(19) United States
(12) Patent Application Publication
(10) Pub. No.: US 2010/0263187 A1
(43) Pub. Date: Oct. 21, 2010

(54) Exhaust Gas Deflector and Shield

(75) Inventor: Thomas M. Matviya, McKees Rocks, PA (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/751,662

(22) Filed: May 22, 2007

Related U.S. Application Data
(63) Continuation-in-part of application No. 11/619,223, filed on Jan. 3, 2007, now Pat. No. 7,628,973.
Application No. 11/619,223 is a continuation-in-part of application No. 11/393,308, filed on Mar. 30, 2006.
(60) Provisional application No. 60/594,355, filed on Mar. 31, 2005.

(51) Int. Cl. B23P 19/04; B32B 3/26

(52) U.S. Cl. 29/428; 428/304.4

(57) ABSTRACT

A shield for deflecting or shielding exhaust gas streams is described. The exhaust shield may comprise a shielding layer comprised of high density carbon foam. The exhaust shield may include an exhaust shield support layer affixed to the shielding layer. In some embodiments the exhaust shield support layer comprises carbon foam. If desired the exhaust shield may be comprised of more than one layer of high density carbon foam or carbon foam. The layers of carbon foam and high density carbon foam may be arranged sequentially through the thickness of the panel. The exhaust shield may be used to protect structures from exhaust gas streams such as those from engines or motors, including jet engines or rocket motors.

### CROSS-REFERENCE TO RELATED APPLICATIONS

This application is a continuation-in-part of U.S. patent application Ser. No. 11/619,223, filed Jan. 3, 2007 entitled “Simultaneous Production of High Density Carbon Foam Sections” which is a continuation-in-part of U.S. patent application Ser. No. 11/393,308, filed Mar. 30, 2006 entitled “High Density Carbon Foam”, which is based on U.S. Provisional Patent Application No. 60/594,355, filed on Mar. 31, 2005, and which all above referenced applications are herein specifically incorporated by reference in their entireties.

### BRIEF BACKGROUND OF THE INVENTION

Exhaust gases from many types of engines and motors exhibit high temperatures, pressures, and flow velocities that may damage materials, equipment, structures, personnel, and the like, herein referred to collectively as structures, exposed to the exhaust gas stream or plume, herein referred to collectively as a exhaust gas stream. This degradation may be exacerbated as the distance of the structure from the source of the exhaust gas stream decreases. In some instances, such degradation may be so severe as to significantly damage or even destroy a contacted structure.

For example, rocket motors may generate exhaust gas streams that have very high temperatures, pressures, and velocities. Additionally, the exhaust gases from rocket motors, which may include flames, may contain particulate material which may further degrade contacted structures. As another example, jet engines may also generate exhaust gas streams having very high temperatures, pressures, and velocities. Other examples may include various types of high performance engines or motors, including internal combustion engines, which exhibit, produce, develop, or otherwise generate high temperature, pressure, and/or velocity exhaust gas streams.

In certain instances, structures potentially located in the exhaust gas stream of such engines or motors may be moved to locations such that the structures are not contacted by the exhaust gas stream. Alternatively, the structures may be located at a distance such that the exhaust gas stream is dispersed prior to contact with the structure. Such positioning of structures, however, may not be always feasible due to space constraints or other application specific requirements. In such situations, it may be necessary to deflect exhaust gas streams and/or to shield surrounding structures from the effects of such exhaust gas streams. For example, jet blast deflectors are used to deflect, diffuse, or otherwise shield structures located behind jet engines from the engine exhaust gas stream. As another example, plume impingement plates, flame deflectors, and the like, have been used to help shield or otherwise protect surrounding structures from the effects of exposure to rocket exhaust gas streams, including flames and particulates.

### BRIEF SUMMARY OF THE INVENTION

Embodiments of the invention may include an exhaust shield for high temperature exhaust gases, where the exhaust shield may comprise a shielding layer having a shielding surface, where the shielding layer includes at least one layer of high density carbon foam. The exhaust shield may further include an exhaust shield support layer affixed to the shielding layer. In some embodiments, the exhaust gas support layer may comprise at least one layer of carbon foam.

Embodiments of the invention may also include a method for shielding structures from high temperature exhaust gases. In some embodiments, the method may comprise the steps of positioning an exhaust shield comprising at least one layer of high density carbon foam between a source of high temperature exhaust gases and a surface of a structure to be protected, where the high density carbon foam has a density ranging from about 1. g/cc to about 2. g/cc. In other embodiments, the exhaust shield may further comprise a second layer of carbon foam positioned between the high density carbon foam and the surface of the structure to be protected. In still other embodiments, the exhaust shield may comprise two or more layers of high density carbon foam. Still further the embodiments may include positioning a second layer of high density carbon foam between the at least one layer of high density carbon foam and the surface of a structure to be protected.

### BRIEF DESCRIPTION OF THE SEVERAL VIEWS OF THE DRAWINGS

FIG. 1 is an illustration of a perspective view of a composite material in accordance with an embodiment of the invention.

FIG. 2 is an illustration of a perspective view of a composite material in accordance with another embodiment of the invention.

FIG. 3 is an illustration of a cross-sectional view of a composite material in accordance with yet another embodiment of the invention.

FIG. 4 is an illustration of a cross-sectional view of a composite material in accordance with still another embodiment of the invention.

FIG. 5 is an illustration of a cross-sectional view of a composite material in accordance with yet an additional embodiment of the invention.

FIG. 6 is an illustration of a cross-sectional view of a composite material in accordance with a further embodiment of the invention.

### DETAILED DESCRIPTION OF THE INVENTION

A shield or deflector to protect structures from exhaust gas streams such as those from engines or motors, including jet engines or rocket motors, in which the shield or deflector utilizes high density carbon foam as a shielding layer, is provided. As used herein, a shield or deflector to protect one or more structures from one or more exhaust gas streams will collectively be referred to as an exhaust shield or exhaust gas shield.

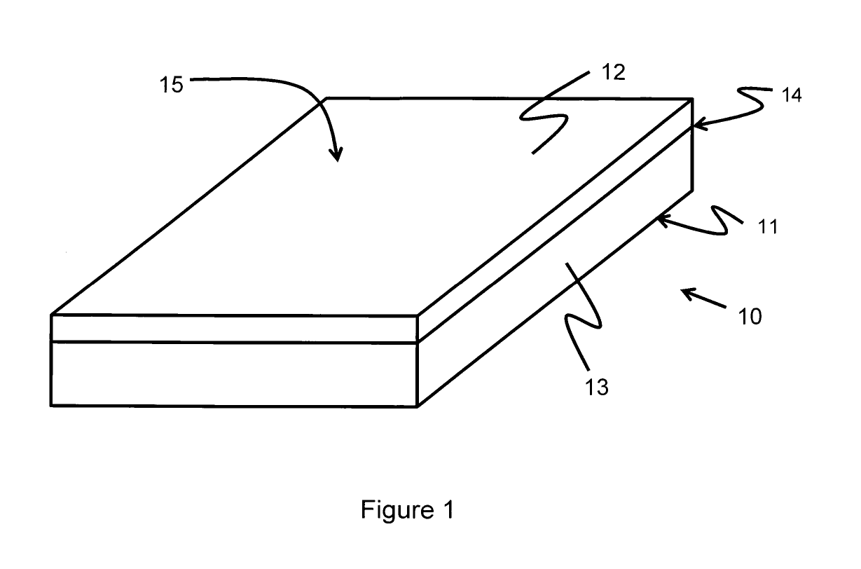

In an embodiment of the invention, an exhaust shield comprises a shielding layer. The shielding layer comprises high density carbon foam. With reference now to FIG. 1, there is illustrated an exhaust shield 10 in accordance with an embodiment of the invention. The exhaust shield 10 comprises a shielding layer 12. As illustrated in FIG. 1, in certain embodiments, the shielding layer 12 may be attached to an exhaust shield support layer 13. In other embodiments, the shielding layer may be attached to a support structure. In still other embodiments, the shielding layer may be located or supported by a non-attached supporting material or structure. The shielding layer 12 and support layer 13 may be bonded together at their mutual contacting surfaces 14 using a bonding material, including, but not limited to an adhesive, binder, glue cement, or other similar bonding material. The adhesive should provide adequate bond strength when subjected to the highest temperature to which the exhaust shield will be exposed when in use. In use, the exhaust shield may be orientated such that the exhaust gas stream(s) primarily contacts the major exposed surface 15 of the shielding layer 14, i.e., the shielding surface.

The shielding layer 12 comprises high density carbon foam. As used herein, high density carbon foam may be referred to as HDCF in the singular or plural tense. The HDCF layer of the shield provides a strong, dense, abrasion resistant, heat resistant, thermal shock resistant, and/or oxidation resistant surface capable of effectively deflecting exhaust gas streams or shielding structures form exhaust gas streams and thus may be used in the shielding layer of the exhaust shield.

HDCF are those carbon foams that exhibit densities of about 1. g/cc or greater. In certain embodiments, the densities may range from about 1. g/cc to about 2. g/cc. In other embodiments, the densities may range from about 1.2 g/cc to about 1.8 g/cc. In still other embodiments, the densities may range from about 1.3 g/cc to about 1.6 g/cc. HDCF, when heated to temperatures greater than about 700° C., and more typically greater than about 950° C., followed by cooling to essentially ambient temperatures, may have compressive strengths (ASTM C365) greater than about 5,000 lbs/in², in some embodiments greater than about 10,000 lbs/in², and in other embodiments greater than about 20,000 lbs/in². Some HDCF may be electrically conductive and exhibit electrical resistivities less than about 0.002 ohm-cm. HDCF may also exhibit good thermal transport properties. In some embodiments, the HDCF may have a thermal conductivity between about 5 to 70 W/mK. In other embodiments, the HDCF exhibits an appreciable (surface) hardness. The body of these HDCF may be largely isotropic. HDCF are materials of very high carbon content that have limited void volume. HDCF are carbon materials. As such, HDCF are primarily comprised of (elemental) carbon.

To the unaided eye, such HDCF may appear to be non-porous solids. However, optical microscopic examination at 10× to 100× may show such HDCF have some degree of porosity. In some embodiments, this porosity is evenly distributed in the foam. The porosity of the HDCF provides void volumes within the foam that are predominately in communication with one another and with the exterior of the foam, thus providing a structure that may be referred to as “open celled” or “porous”.

In some embodiments, optical microscopic examination at a magnification of about 90× shows the HDCF are not simply comprised of sintered powders. That is, the vast majority of the coal particulates from which the foam was prepared are predominantly no longer recognizable as individual particles bonded together only at their areas of mutual contact, as would be the case in a sintered material. In appearance, the microscopic structure of the HDCF may appear similar, but not equivalent, to the structures of both low density coal based carbon foams and reticulated vitreous carbons. That is, the HDCF may be comprised of defined, regular, void spaces delimited by thick, somewhat curved, interconnected carbon ligaments, which result in a continuous, open-celled, foam-like dense carbon body. Typically, the void spaces of the HDCF do not have a high population of the wide curving walls usually present in the well-defined spherical voids of lower density (densities less than 1. g/cc, and more typically less than 0.5 g/cc) coal based carbon foams. The void spaces of the HDCF materials are typically significantly smaller than those observed in a lower density carbon foam material.

In other embodiments, the structure of the HDCF may appear, under microscopic examination at about 90×, to be comprised of numerous randomly interconnected and intertwined small carbon ligaments of random size and orientation. Such interconnected ligaments are continuous through the HDCF. The surfaces of these ligaments may be curved and relatively smooth, non-uniform, irregular, or even occasionally embedded with what may be the remains of coal particles that did not achieve a high degree of plastic character. In such embodiments, void spaces defined by the ligaments may be of random size and shape with limited, if any, spherical characteristics. In some embodiments, the size and number of void spaces may be inversely related to the density of the HDCF. That is, higher density HDCF may exhibit fewer, and smaller, void volumes than do lower density HDCF. Additionally, higher density HDCF may exhibit thicker ligaments than do lower density HDCF. While the pores sizes may vary within a single piece of HDCF, the majority of the pores have a relatively consistent pore size.

In some embodiments, suitable HDCF may include those HDCF disclosed in U.S. patent application Ser. No. 11/393,308 filed Mar. 30, 2006, which is specifically herein incorporated by reference in its entirety, and U.S. patent application Ser. No. 11/619,223, filed Jan. 3, 2007 which also is specifically herein incorporated by reference in its entirety. These patent applications disclose HDCF and methods for producing such foams, with emphasis on the direct production from coal.

With continuing reference to FIG. 1, the shielding layer 12 may comprise a composite comprising HDCF. For example, the surface of the HDCF potentially exposed to the exhaust gas stream may be coated or impregnated with any of a number of materials to increase the shielding or deflection effectiveness of the HDCF. In some embodiments, surface coatings may include, but are not limited to, ceramics or ceramic precursors, metals, paints, carbon, graphite, thermoplasitc or thermosetting polymeric materials (including but not limited to, epoxies, phenolic resins, nylons, polycarbonates, acrylics, polyethylene, polypropylene, polystyrene, and the like), cellulose based materials including wood, composites, fibers, tars and other similar high viscosity organic materials including pitches and asphalts, and other similar materials. In some embodiments, the exhaust shield may comprise a composite of HDCF and carbon foam assembly as disclosed in U.S. patent application Ser. No. 11/751,651, entitled “Carbon Foam and High Density Carbon Foam Assembly,” filed on May 22, 2007, herein incorporated by reference in its entirety.

As illustrated in FIG. 1, the exhaust shield 10 may include a shielding layer 12 which may be affixed to an exhaust shield support layer 13. The exhaust shield support layer 13 provides structural support for the shielding layer 12 when in use as an exhaust shield. The exhaust shield support layer 13 should have sufficient strength and stiffness to support the shielding layer 12. The exhaust shield support layer may be continuous or non-continuous. The materials for use as the exhaust shield support layer may include, but are not limited to, steel, stainless steel, iron, other metals, high temperature composites, ceramics, ceramic composites, and the like. The shielding layer 12 may be affixed to the exhaust shield support layer by use of adhesives or resins or may be affixed by known mechanical fasteners such as nuts and bolts, screw type fasteners, clips, straps, and other similar fasteners.

In certain embodiments, the exhaust shield support layer 13 may comprise carbon foam. The carbon foam, if utilized, provides a strong, heat resistant, thermal shock resistant, and/or oxidation resistant support for the high density carbon foam. Further, the carbon foam and HDCF of the shielding layer will have similar coefficients of thermal expansion such that when the exhaust shield is exposed to a high temperature, thermal expansion mismatch between the exhaust shield support layer 13 and the shielding layer 12 will be minimized.

Carbon foams are materials of very high carbon content that have appreciable void volume. In appearance, excepting color, carbon foams resemble readily available commercial plastic foams. As with plastic foams, the void volume of carbon foams is located within numerous empty cells. The boundaries of these cells are defined by the carbon structure. These cells typically approximate ovoids of regular, but not necessarily uniform, size, shape, distribution, and orientation. The void volumes in these cells may directly connect to neighboring void volumes. Such an arrangement is referred to as an open-cell foam. The carbon in these foams forms a structure that is continuous in three dimensions across the material. Typically, the cells in carbon foams are of a size that is readily visible to the unaided human eye. Also, the void volume of carbon foams is such that it typically occupies much greater than one-half of the carbon foam volume. The densities of carbon foams are typically less than about 1. g/cc. In some embodiments, the densities of carbon foam may range from about 0.05 g/cc to about 0.8 g/cc. In some embodiments, carbon foams may exhibit compressive strengths ranging up to about 10,000 psi. In other embodiments, the compressive strength for carbon foam may range from about 100 psi to about 10,000 psi. In certain other embodiments, compressive strengths for carbon foam may range from about 400 psi to about 7,000 psi. The carbon foam used for a carbon foam section of the exhaust shield support layer may be carbonized carbon foam. Alternatively, if desired, the carbon foam used for a carbon foam section of the exhaust shield support layer may be graphitized carbon foam.

Carbon foams have been produced from a number of starting materials (i.e. feedstocks) including, but not limited to, coal, pitch, mesophase materials, polymers, polymeric foams, hydrogenated coals and associated extracts, solvent refined coals and extracts, and the like. Carbon foams prepared directly from coal are disclosed in U.S. Pat. No. 6,814,765, which is specifically herein incorporated by reference in its entirety, and U.S. patent application Ser. No. 11/142,960 filed Jun. 20, 2005, which is also specifically herein incorporated by reference in its entirety.

The regular size, shape, distribution, and orientation of the cells within carbon foam readily distinguish this material from other carbon materials such as metallurgical cokes. The void volumes within cokes are contained in cell-like areas of typically ovoid shape and random size, distribution, and orientation. That is, in cokes, some void volumes can be an order of magnitude, or more, larger than others. It is also not uncommon that the over-lapping of void volumes in cokes results in significant distortions in the void shape. These distortions and large void volumes can even lead to a product that has limited structural integrity in all except smaller product volumes. That is, it is not uncommon for coke to be friable and larger pieces of coke to readily break into smaller pieces with very minimal handling. Such breakage is typically not exhibited by carbon foams. Also, a given sample of coke can exhibit both open and closed-cell void volumes.

With respect to the materials used for the exhaust shield, in some embodiments, those carbon foams and HDCF prepared directly from coal are particularly useful as such materials may exhibit low coefficients of thermal expansion, high strengths (even at elevated temperatures), high thermal stability and thermal shock resistance, and low rates of oxidation when exposed to elevated temperatures in air.

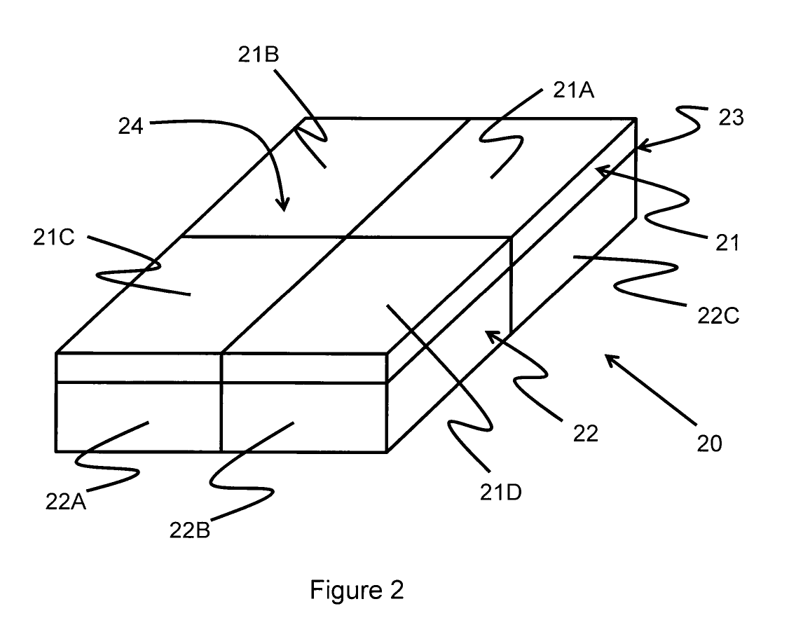

The size and shape of the exhaust shield is not particularly limited and may include virtually any size or shape. The exhaust shield may be configured as a panel. Depending upon the size or desired configuration of the exhaust shield, the one or more sections of HDCF may be used. As illustrated in FIG. 2, another embodiment of an exhaust shield 20, shaped as a panel, useful for a shield for shielding structures from exhaust gas streams or for deflecting such gases is shown. In this embodiments, the exhaust shield 20 is comprised of a shielding layer 21 comprising more than one sections of HDCF 21A, 21B, 21C, and 21D bonded together using a bonding material as discussed above. The sections of HDCF are affixed to the exhaust shield support layer 22 comprised of more than one section 22A, 22B, and 22C. The shielding layer 21 and the exhaust shield support layer 22 may be affixed together at their mutual contacting surfaces 23 as discussed above.

The surfaces of the layers of the exhaust shield may be shaped to provide, for example, increased surface areas for increased adhesive bonding strength. Additionally, one or more outer surfaces of the composite material may be shaped or roughened to increase its coefficient of friction. Additionally, the layers may be shaped to provide channels for fluid transfer within or through the composite material. Such fluid transfer may provide for the passage of a cooling fluid through the composite material and thus mitigate the effect of the temperatures to which the composite material is exposed. Furthermore, the layers of the composite material may be shaped to inhibit heat transfer between layers and/or to increase the strength to weight ratio of the composite material.

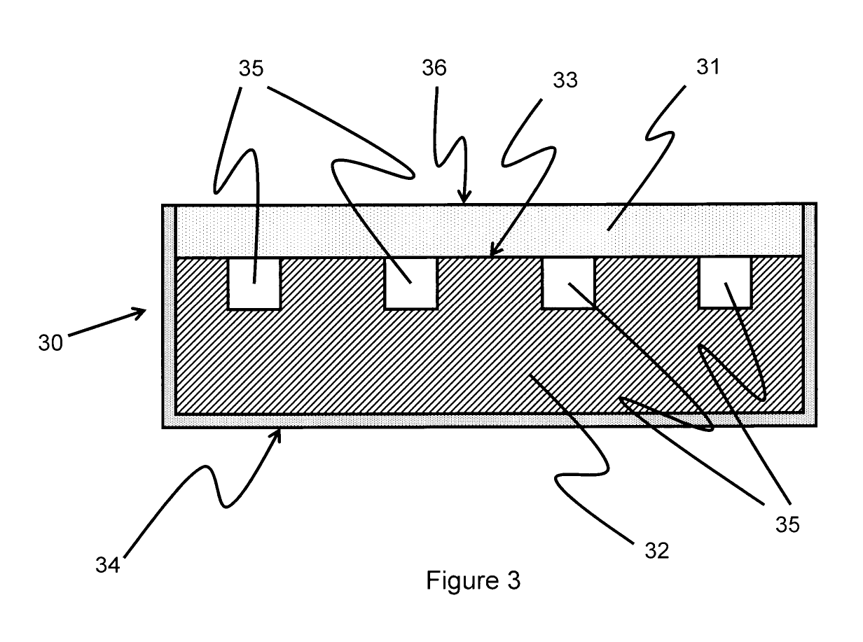

For example, FIG. 3 provides an illustration of a cross-sectional view of a section of an exhaust shield 30, shaped as a panel, useful for a shield for shielding structures from exhaust gas streams or for deflecting such gases, in accordance with another embodiment of the invention. This exhaust shield is comprised of a shielding layer 31 and an exhaust shield support layer 32. These layers are arranged sequentially through the thickness of the exhaust shield. The shielding layer 31 and exhaust shield support layer 32 are affixed together at their mutual contacting surfaces 33 using an adhesive. The adhesive provides adequate bond strength when subjected to the highest temperature to which the composite will be exposed when used as an exhaust shield. A surface coating 34 is bonded to the bottom and sides of the exhaust shield. The surface coating 34 may include impermeable dense ceramic or ceramic composite material. The exhaust shield support layer 32 has a number of parallel channels 35 machined in the surface near the shielding layer 31. In use, the exhaust shield is orientated such that the exhaust gas streams primarily contact the major exposed surface 36 of the shielding layer 31. A fluid may be passed through the channels 35 to remove heat imparted to the exhaust shield 30 by the exhaust gas. If the shielding layer 31 is not sealed or otherwise densified or impregnated, some of this cooling fluid may pass through the HDCF further removing heat imparted by the exhaust gas. In some embodiments, the shielding layer 31 may be surface coated, sealed, or impregnated to inhibit passage of the fluid out of the HDCF. The surface coating 34 prevents or reduces the fluid from leaking from the exposed surfaces of the exhaust shield support layer. In some embodiments, such leaking may be desired and the surface coating 34 may be partially or totally eliminated.

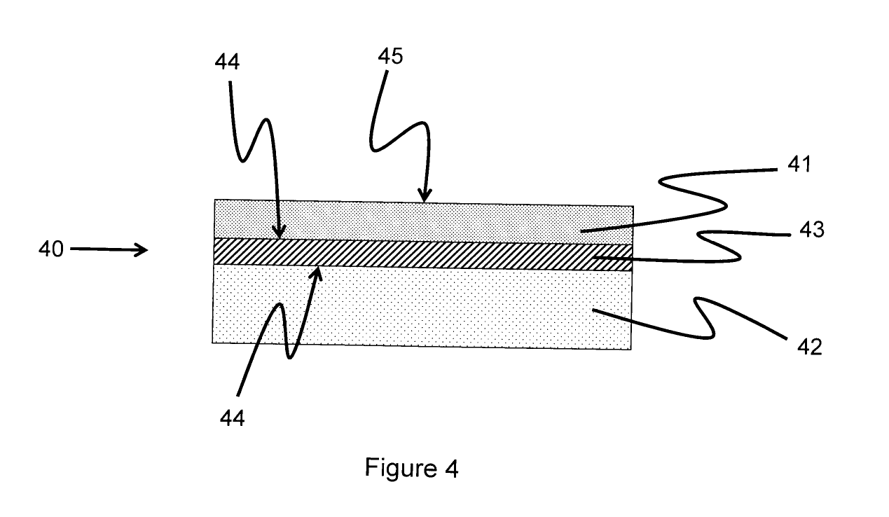

In some embodiments, insulating materials may be incorporated into the exhaust shield. For example, insulating materials may cover exposed surfaces of the exhaust shield. In other embodiments, the insulating materials may comprise an insulating layer covering one or more surfaces of the shielding layer and/or exhaust shield support layer. In some embodiments, an insulating layer may be positioned between the shielding layer and the exhaust shield support layer. For example, FIG. 4 provides an illustration of a cross-sectional view of a section of an exhaust shield 40, shaped as a panel, useful for a shield for shielding structures from exhaust gas streams or for deflecting such gases, in accordance with another embodiment of the present invention. In this embodiment the exhaust shield 40 is comprised of a shielding layer 41 and an exhaust shield support layer 42. These layers are separated by an insulating layer 43. The shielding layer 41, the exhaust shield support layer 42, and the insulating layer 43 may be bonded together at surfaces 44 using an adhesive. The adhesive should provide adequate bond strength when subjected to the highest temperature to which the exhaust shield 40 will be exposed when used as an exhaust shield. In use, the composite material is orientated such that the exhaust gas streams primarily contact the major exposed surface 45 of the shielding layer 41. The insulating layer 43 inhibits heat transfer from the shielding layer 41 to the exhaust shield support layer 42. Such an inhibition may enable the exhaust shield support layer 42 to maintain a lower temperature than would otherwise be possible without the presence of the insulating layer 43.

The insulating layer may comprise insulating materials such as, but not limited to, ceramics, ceramic composites, and glasses. In various embodiments, the insulating layer may be incorporated into or on the exhaust shield, for example, as a solid panel, a sheet, a paste, a fiber mat, a ceramic foam, a castable mixture, high temperature composite, or the like.

In still other embodiments, various strengthening materials may be incorporated into the exhaust shield. Such strengthening materials may include, but are not limited to, glass fibers, ceramic fibers, carbon/graphite fibers, and carbon-carbon composites. For example, glass fibers, ceramic fibers and/or carbon/graphite fibers may be incorporated into the insulating layer to provide for additional insulating material strength. Alternatively, such fibers may be incorporated into the adhesive(s) used to bond the layers of the shielding layer and exhaust shield support layer together. Carbon-carbon composites may be incorporated into the exhaust shield in much the same manner as fibers. Alternatively, carbon-carbon composites may comprise a layer on one or more surfaces of the exhaust shield, shielding layer, or exhaust shield support layer.

Other strengthening materials may be incorporated in or on the exhaust shield provided that, in use, the temperature of the composite material in the area of incorporation does not reach a temperature sufficient to cause such other strengthening materials to fatally degrade. Such other strengthening materials may include, but are not limited to, polymeric composites, metallic composites, polymers, metals, concrete, ceramics, ceramic composites, refractory materials, and the like

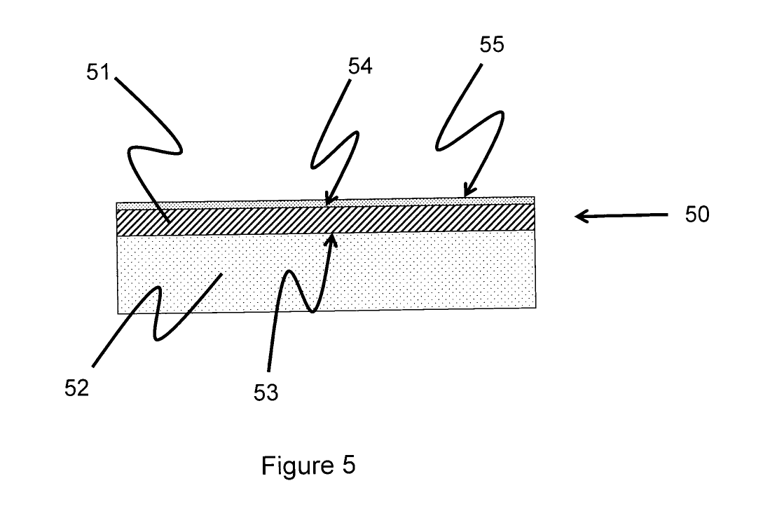

With reference now to FIG. 5, there is illustrated a cross-sectional view of a section of an exhaust shield 50, shaped as a panel, useful as a shield for shielding structures from exhaust gas streams or for deflecting such gases, in accordance with another embodiment of the invention. The exhaust shield 50 is comprised of a shielding layer 51 and an exhaust shield support layer 52. The 1 shielding layer 51 and exhaust shield support layer 52 may be bonded together at their mutual contacting surfaces 53 using an adhesive. The adhesive should provide adequate bond strength when subjected to the highest temperature to which the composite will be exposed when used as an exhaust shield. The exposed surface 54 of the shielding layer 51 is coated and/or impreganted with a surface coating 55 as described above. Such a surface coating may serve, for example, to increase the surface oxidation resistance, to increase the surface hardness, to increase the surface coefficient of friction, or to decrease the surface porosity. In use, the composite material is orientated such that the exhaust gas streams primarily contact the major exposed surface 54 of the shielding layer 51 or the surface coating 55 applied thereon.

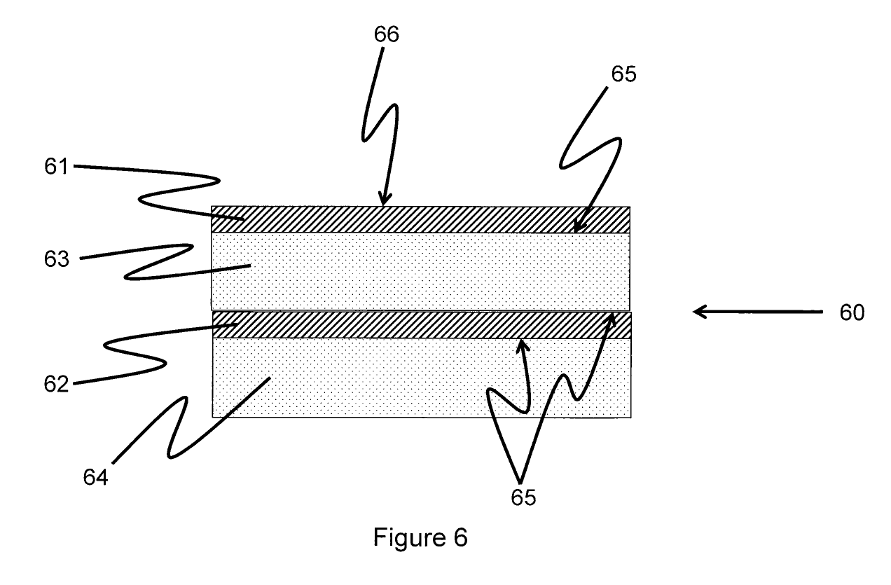

FIG. 6 provides an illustration of a cross-sectional view of a section of an exhaust shield 60, shaped as a panel, useful for a shield for shielding structures from exhaust gas streams or for deflecting such gases, which encompasses another embodiment of the invention. This exhaust shield is comprised of two layers of HDCF 61 and 62 and two layers of carbon foam 63 and 64. The layers of carbon foam and HDCF are bonded together at their mutual contacting surfaces 65 using an adhesive. The adhesive provides adequate bond strength when subjected to the highest temperature to which the composite will be exposed when used as an exhaust shield. In use, the exhaust shield is orientated such that the exhaust gas streams primarily contact the major exposed surface of the outermost HDCF 66. If the conditions of exposure are such that the exhaust gas essentially destroys the top layer of HDCF 61, and the topmost layer of carbon foam 63, a second layer of HDCF and carbon foam are present. These second layers within the composite material may then serve to shield structures from exhaust gas streams or deflect such gases.

The layers of the exhaust shield, including the shielding layer, exhaust shield support layer, and any insulating materials and/or strengthening materials, may be bonded together using an adhesive. In a similar manner, any layer using multiple sections of HDCF, carbon foam, or other materials, may typically be bonded together using an adhesive. Suitable adhesives are those adhesives that may be exposed to the maximum temperature to which the composite material may be exposed while still maintaining acceptable bond strength. Such adhesives may include, but are not limited to, graphite adhesives, ceramic adhesives, and inorganic cements including magnesia cements or silica cements. Other suitable adhesives may include thermosetting polymeric materials, especially carbonizing thermosetting polymeric materials, such as, for example, phenolic resins, melamine resins, and furan resins. In some embodiments, the other insulating material may serve to bond together the layers of the composite, including the carbon foam and/or HDCF.

The outer surfaces of the exhaust shield, the shield layer, and/or the exhaust shield support layer may be surface coated or impregnated with various materials. Such materials may serve, for example, to increase the surface oxidation resistance, to increase the surface hardness, to increase the surface coefficient of friction, or to decrease the surface porosity. In some embodiments, such materials may be ceramics or ceramic precursors. In other embodiments, such materials may be those that substantially convert to carbon when heated to elevated temperatures. Such materials may include, but are not limited to, furan resins, phenolic resins, furfurol alcohol, pitches, tars, bitumins, and the like.

In some embodiments, once formed, the exhaust shield may be exposed to temperatures at least as great as that to which the composite material will be exposed in use. Alternatively, the layers of the exhaust shield, including the high density carbon foam, carbon foam, and any insulating materials and/or strengthening materials, may be heated individually to a temperature at least a high as that to which the resulting composite material will be exposed in use. Such heating may serve to dimensionally stabilize each of the materials and inhibit cracking or breakage of the composite material in use. Such heating of any of the carbon materials is preferably conducted in an essentially inert atmosphere to prevent extraneous oxidation.

In some embodiments, the exhaust shield may be positioned between a structure to be protected from exhaust gas streams and the source of those gases. When so positioned, the exhaust shield is orientated such that the exhaust gas streams primarily contact the surface of the shielding layer comprising HDCF.

While the invention has been described above in detail with respect to certain embodiments, the present invention is limited only by the following appended claims.

What is claimed is:

1. An exhaust shield for high temperature exhaust gases, the exhaust shield comprising
a shielding layer having a shielding surface, wherein said shielding layer is comprised of at least one layer of high density carbon foam; and
an exhaust shield support layer affixed to the shielding layer.

2. The exhaust shield of claim 1, wherein said at least one layer of high density carbon foam has a density ranging from about 1. g/cc to about 2. g/cc.

3. The exhaust shield of claim 1, wherein said at least one layer of high density carbon foam has a density ranging from about 1.2 g/cc to about 1.8 g/cc.

4. The exhaust shield of claim 1, wherein said at least one layer of high density carbon foam has a density ranging from about 1.3 g/cc to about 1.6 g/cc.

5. The exhaust shield of claim 1, wherein said exhaust gas support layer comprises at least one layer of carbon foam.

6. The exhaust shield of claim 5, wherein said at least one layer of carbon foam has a density ranging from about 0.05 g/cc to less that about 0.8 g/cc.

7. A method for shielding structures from high temperature exhaust gases, the method comprising the steps of:
positioning an exhaust shield comprising at least one layer of high density carbon foam between a source of high temperature exhaust gases and a surface of a structure to be protected, wherein the high density carbon foam has a density ranging from about 1. g/cc to about 2. g/cc.

8. The method of claim 7, wherein the exhaust shield further comprises a second layer of carbon foam positioned between the high density carbon foam and the surface of the structure to be protected.

9. The method of claim 7, wherein the exhaust shield comprises two or more layers of high density carbon foam.

10. The method of claim 7, further comprising the step of positioning a second layer of high density carbon foam between the at least one layer of high density carbon foam and the surface of a structure to be protected.
